(19) United States
(12) Patent Application Publication
(10) Pub. No.: US 2023/0129022 A1
(43) Pub. Date: Apr. 27, 2023

(54) METHOD AND SYSTEM FOR REDUCING NOISE

(71) Applicant: Faurecia Creo AB, Linkoping (SE)

(72) Inventors: Tristan PEPIN, Paris (FR); Nicolas PIGNIER DELAFONTAINE, Sollentuna (SE)

(21) Appl. No.: 17/972,293

(22) Filed: Oct. 24, 2022

(30) Foreign Application Priority Data
Oct. 25, 2021 (EP) 21204578.5

(51) Int. Cl. G10K 11/178

(52) U.S. Cl. CPC G10K 11/17815; G10K 11/17817; G10K 11/17825; G10K 11/17823; G10K 11/17881; G10K 2210/3038; G10K 2210/30232; G10K 2210/12821; G10K 2210/3028; G10K 2210/3012; G10K 2210/3026; G10K 2210/3027

(57) ABSTRACT

A method for reducing noise within a vehicle cabin comprising at least one error sensor and at least one sound transducer, the method comprising: the at least one error sensor measuring at least one first noise at a first location; selecting at least one sound zone from a plurality of sound zones within the cabin for reducing noise in said at least one sound zone, based on a presence of a driver and passenger(s) within the cabin; estimating at least one second noise that would have been measured at a second location within the selected at least one sound zone, based on a primary transfer function describing a primary acoustic path from the first location to the second location; the at least one sound transducer generating at least one secondary noise for reducing the at least one second noise that would have been measured at the second location.

### CROSS-REFERENCE TO RELATED APPLICATION

This application claims the benefit of priority of European Patent Application No. 21204578.5, filed Oct. 25, 2021, the content of which is incorporated by reference in its entirety for all purposes.

### TECHNICAL FIELD

The present document relates to a method and system for reducing noise within a cabin of a vehicle. In particular, it relates to a method and system for reducing noises at a location where no error sensor is provided.

### BACKGROUND

Methods and systems for actively controlling noises, e.g., road noises, within a vehicle cabin, are widely studied. Such a method is often performed with the help of a feedforward control system, such as an Active Noise Control (ANC) system or an Active Road Noise Control (ARNC) system.

The feedforward control systems typically involve:

i) one or several reference sensor(s), e.g., microphone(s), for measuring primary noises at one or more noise sources;

ii) one or several sound transducer(s), also known as secondary sound sources, e.g. loudspeakers of an existing audio system of a vehicle, for generating secondary noises to cancel the primary noises;

iii) one or several error sensor(s) for measuring a noise, being a superposition of the primary noises and the secondary noises, at different positions within the vehicle cabin; and

iv) a control circuit, typically a digital signal processor (DSP), to generate one or several control signals for driving the sound transducer(s) to generate the secondary noises for reducing the primary noises.

The reference sensor may generate a reference signal representing the primary noise measured at the primary noise source.

The error sensor may generate an error signal representing the noise measured by the error sensor.

The control signals may be generated by filtering reference signals generated by the reference sensor(s) and the error signals generated by the error sensor(s) with an adaptive filter. The adaptive filter may be updated by an adaptive algorithm, typically a least mean square (LMS) algorithm, to reduce the noises measured by the error sensor(s). In other words, the goal is to reduce the noises measured by the error sensor(s), or the corresponding error signals.

Normally, a plurality of microphones is provided within the vehicle cabin in order to monitor noises at a plurality of different locations within the vehicle cabin. With the ANC system, an overall noise within the vehicle cabin can be reduced by reducing the error signals at each of the plurality of locations. However, the noise reduction is most effective at the locations of the microphones, and since the microphones are typically not placed at the exact positions of ears or heads of the driver and passengers within the cabin, the noise reduction cannot be not optimal for them.

A distance between the microphones and the ears of the driver or the passengers limits not only the effective frequency range of the noise reduction, but also the perceived performance of the ANC system.

Remote Microphone Technique (RMT) is a technique proposed to improve the noise cancelling effect. By using a concept of a virtual microphone which does not exist, the noise cancellation zone can be moved from the existing microphones to any location of the virtual microphone, e.g., the ears positions of the passengers. For example, “Performance evaluation of an active headrest using the remote microphone technique”, Prasad Das D, Moreau D and Cazzolato B, Proceedings of ACOUSTICS 2011, 2-4 Nov. 2011, Gold Coast, Australia, and “Local active control of road noise inside a vehicle”, Jung, W., Elliott, S. J., & Cheer, J. (2019), Mechanical Systems and Signal Processing, 121, 144-157, relate to using RMT to improve noise reduction in the vehicle cabin. However, the estimation of the sound captured by the virtual microphone is not accurate enough for providing a good noise cancellation effect.

Hence, there is a need to provide a method and system for reducing noises within a cabin of a vehicle, which can provide an improved global noise reduction.

### SUMMARY

The invention is defined by the appended independent claims. Embodiments are set forth in the appended dependent claims, and in the following description and drawings.

According to a first aspect, there is provided a method for reducing noise within a cabin of a vehicle comprising at least one error sensor and at least one sound transducer. The method comprises:

the at least one error sensor measuring at least one first noise at a first location within the cabin, wherein the at least one error sensor is provided at the first location;

selecting at least one sound zone from a plurality of sound zones within the cabin for reducing noise in said at least one sound zone, based on a presence of a driver and passenger(s) within the cabin, wherein the selected at least one sound zone corresponds to at least one zone occupied by the driver and/or passenger(s);

estimating at least one second noise that would have been measured at a second location within the selected at least one sound zone, based on a primary transfer function describing a primary acoustic path from the first location to the second location; and

the at least one sound transducer generating at least one secondary noise for reducing the at least one second noise that would have been measured at the second location.

The inventive concept is to select at least one sound zone based on a presence of a driver and passenger(s) within the cabin, then use the transfer functions which have been accurately determined in advance, e.g., by machine learning, and the noises measured by the at least one error sensor, e.g., a control microphone, to accurately estimate the noise that would have been measured by a virtual microphone provided at the second location within the selected at least one sound zone. Based on the estimation, the noise at the virtual microphone can be reduced, which can lead to an improved noise reduction at the location of the virtual microphone, and in the selected at least one sound zone.

By using the invention to cancel a primary noise within a moving vehicle, the driver and all passengers would perceive a much improved noise reduction at higher frequencies, than using the traditional ANC system combined with RMT.

Further, since the sound zone(s) can be selected, it is possible to selectively reduce noise for one or more specific sound zone(s).

A sound zone may be a volume within an acoustic cavity, i.e. the cabin of the vehicle. The sound zone may be a volume around a head and/or ears of the driver, and/or the passenger(s). The plurality of sound zones may be a plurality of volumes respectively around the head and/or ears of the occupants of different seats within the cabin.

By selecting the sound zone(s), it is possible to selectively reduce noise for one or more specific persons that would sit on one or more seats.

The selected at least one sound zone corresponds to one or more zones (volumes) occupied by the driver and/or the passenger(s), i.e. where the driver and/or the passenger(s) that is/are present within the cabin.

Each sound zone may have a respective second location. The second location may be a location within the vehicle cabin where the noise is to be cancelled. The second locations of the sound zones may be different from each other.

The second location may be a location corresponding to a tiny volume within the selected sound zone. The second location may be an averaged position of ears of the driver or of one passenger. The second location may be a location of an ear or a head of the driver or of one passenger. The second location may be an averaged centre position of the driver's or passenger's head, an averaged position of the driver's or passenger's ears, an average position of two passenger's heads, or any other positions within the cabin.

By accurately estimating the second noise that would have been measured at the second location within the selected sound zone, the noise perceived (e.g., heard) by the driver or the passengers can be reduced.

For example, the present occupants may be the driver sitting at a driver seat, and one passenger sitting at a rear left seat. Other seats are unoccupied. The sound zones corresponding to the driver and that passenger may be selected. The second locations within the selected sound zones may be the positions of the head and/or ears of the driver and that passenger. The sound zones corresponding to the other passengers may not be selected. The selection of the sound zone(s) (the second location(s)) may be done manually.

Alternatively, or in combination, the selection of the sound zone(s) (the second location(s)) may be done automatically.

For example, the selection of the sound zone(s) (the second location(s)) may be done based on information retrieved from an existing vehicle system, e.g., information of the occupied seats of the vehicle. The vehicle system may monitor the driver and/or the passengers of the vehicle.

The information may be a status of a seatbelt. An extended and fastened seatbelt may imply that the seat is occupied and a person (a passenger or a driver) is sitting on this seat. The sound zone corresponding to this person sitting on this seat may be selected. The second location of the selected sound zone may be an averaged position of the ears of the person sitting on this seat. An unfastened seatbelt may imply that the seat is unoccupied and there is no one sitting on this seat. Consequently, there is no need to cancel noise for the empty seat. Thus, the sound zone corresponding to a person that would sit on this seat may not be selected.

Since the noise at the second location of the selected sound zone can be accurately estimated, there is no need to provide additional microphones at these locations for measuring the noises. This may simplify the integration of the system and the vehicle.

Further, using a reduced number of microphones can reduced both the cost of the system and the cost for implementing the system.

The method may be an ANC method, or an ARNC method for cancelling a primary noise within a cabin of a vehicle.

The method may be used to reduce noise within a cabin of a car, a truck, a train, an airplane, and any other types of vehicles.

The system for implementing the method may be an ANC system.

At least one reference sensor may measure at least one primary noise at a primary noise source. The at least one reference sensor may generate at least one reference signal representing the at least one primary noise measured at the primary noise source.

The primary transfer function may describe a primary acoustic path of the primary noise from the first location to the second location.

The at least one error sensor may generate at least one first error signal representing the at least one first noise measured by the at least one error sensor.

At least one second error signal representing the at least one second noise that would have been measured at the second location may be estimated, based on the primary transfer function.

The at least one sound transducer may generate the at least one secondary noise for reducing the at least one primary noise at the second location.

The step of estimating at least one second noise may comprise:
calculating the primary transfer function by machine learning, comprising:
   providing a plurality of first noises respectively measured at the first location under a plurality of operating conditions;
   providing a plurality of second noises respectively measured at the second location under the plurality of operating conditions;
   inputting the plurality of first noises and the plurality of second noises to a neural network;
   the neural network predicting a plurality of predicted second noises based on the plurality of first noises and a preliminary primary transfer function, wherein a difference between the plurality of predicted second noises and the plurality of second noises is an error of prediction;
   the neural network optimizing the preliminary primary transfer function for reducing the error of prediction;
   wherein the optimized preliminary primary transfer is the calculated primary transfer function.

Calculating the primary transfer function by machine learning may comprise:
providing a plurality of first data representing the plurality of the first noises respectively measured at the first location under the plurality of operating conditions;
providing a plurality of second data representing the plurality of the second noises respectively measured at the second location under the plurality of operating conditions;
inputting the plurality of first data and the plurality of second data to a neural network;
the neural network predicting a plurality of predicted second data based on the plurality of first data and a preliminary primary transfer function, wherein a difference between the plurality of predicted second data and the plurality of second data is an error of prediction.

The number of the plurality of first noises may be at least ten. The number of the plurality of second noises may be the same as the number of the first data.

The plurality of first noises and the plurality of second noises have a one-to-one corresponding relationship. In other words, the plurality of first noises and the plurality of second noises may be considered as a plurality of pairs of noises, each pair of noises comprising a first noise and a second noise. The first noise and the second noise of each pair of noises may be collected by one measurement under one operating condition. In this way, the primary transfer function can be predicted by using each of the first noise and its corresponding second noise (the second noise of the same pair of noises).Each of the plurality of first noises may comprise a recording recorded by the error sensor provided at the first location, under an operating condition.

Each of the plurality of second noises may comprise a recording recorded by a sensor, e.g., a monitor sensor, provided at the second location, under an operating condition.

Each recording may have a length of at least 60 seconds. Each recording may comprise information of the noise measured at the first or second location, such as a sound pressure.

The plurality of operating conditions may comprise any of: a surface condition of a road, a speed of the vehicle, revolutions per minute of a motor of the vehicle, a type of a tire of the vehicle, and an interior configuration of the cabin.

Different operating conditions may influence the primary noise to be cancelled within the cabin. For example, a rough road surface and a smooth road surface may generate different road noises. Winter tires and summer tires may generate different road noises. The same type of vehicles having different interior configurations of the cabin, such as the different numbers of seat rows, the different numbers of seats, with or without a panoramic roof, etc., may influence the primary transfer function.

Thus, calculating the primary transfer function under different operating conditions may improve the accuracy of the estimation of the second noise and the second error signal.

The method may comprise repeating the step of the neural network predicting a plurality of predicted second noises and the step of the neural network optimizing the preliminary primary transfer function, until the error of prediction is less than a predetermined threshold.

The step of calculating the primary transfer function may comprise the neural network optimizing a preliminary primary transfer function for a second location within each sound zone of the plurality of sound zones. The method may comprise using the primary transfer function optimized for the second location of the selected at least one sound zone for estimating the at least one second noise.

It is advantageous as the primary transfer function may be calculated for each second location, for each sound zone, and for each present driver and passengers.

Depending on the presence of the driver and passenger(s) within the cabin, only the primary transfer function optimized for the second location of the selected sound zone may be activated for estimating the second noise. The primary transfer functions optimized for the second locations of the unselected sound zones may be deactivated and not used for estimating the second noise.

The step of estimating at least one second noise may comprise:
calculating a secondary transfer function describing a secondary acoustic path of the at least one secondary noise from the at least one sound transducer to each of the first and second location, and
estimating the at least one second noise based on the at least one first noise, the at least one secondary noise, the primary transfer function, and the secondary transfer function.

Estimating the at least one second noise may comprise estimating the at least one second error signal based on the at least one first error signal, the at least one secondary noise, the primary transfer function, and the secondary transfer function.

The step of calculating a secondary transfer function may comprise:

providing at least one monitor sensor at the second location,

the at least one sound transducer generating at least one noise for calibration,

the at least one error sensor measuring the at least one noise for calibration at the first location,

the at least one monitor sensor measuring the at least one noise for calibration at the second location,

calculating the secondary transfer function based on the at least one noise for calibration, and the measured noises for calibration at the first and second location, respectively, and

removing the at least one monitor sensor from the second location.

The noise for calibration may be a broadband noise.

The broadband noise may be any one or any combination of a white, a pink, and a brown noise.

The method may comprise at least one reference sensor measuring at least one primary noise at a primary noise source. The at least one first and second noise may be a superposition of the at least one primary noise and the at least one secondary noise at the first and second location, respectively.

The at least one reference sensor may generate at least one reference signal representing the at least one primary noise measured at the primary noise source.

The method may comprise generating a control signal by executing an adaptive filtering algorithm, comprising updating an adaptive filter based on the measured at least one primary noise and the estimated at least one second noise by executing the adaptive filtering algorithm; generating the control signal by filtering the measured at least one primary noise by the updated adaptive filter; and the at least one sound transducer generating the at least one secondary noise, in response to the control signal, for reducing the at least one primary noise at the second location.

The adaptive filtering algorithm may be a filtered-x least mean square, FxLMS, algorithm.

The step of estimating at least one second noise may comprise:

calculating a secondary signal êₛ(n) representing the at least one secondary noise that would have been measured at the first location, based on the control signal and the secondary transfer function from the at least one sound transducer to the first location; calculating a primary signal ê₀(n) representing the at least one primary noise that would have been measured at the first location, based on the at least one first noise and the secondary signal êₛ(n);

calculating a primary signal ê₀^{(v)}(n) representing the at least one primary noise that would have been measured at the second location, based on the primary signal ê₀(n) at the first location and the primary transfer function;

calculating a secondary signal ê₀^{(v)}(n) representing the at least one secondary noise that would have been measured at the second location, based on the control signal and the secondary transfer functions from the at least one sound transducer to the second location; and

calculating a second error signal ê^{(v)}(n) based on the primary signal ê₀^{(v)}(n) and the secondary signal ê₀^{(v)} (n).

The second error signal ê^{(v)}(n) may represent the at least one second noise that would have been measured at the second location.

The primary signal ê₀(n) representing the primary noise that would have been measured at the first location may be calculated based on the at least one first error signal and the secondary signal ê_{S}(n).

The step of the neural network optimizing the preliminary primary transfer function may comprise using an Adaptive Moment Estimation, ADAM, optimizer, for optimizing the preliminary primary transfer function.

The step of the neural network optimizing the preliminary primary transfer function may comprise:

calculating a gradient of the error of prediction;

updating a momentum vector m and a velocity vector v;

calculating a predicted momentum vector m and a predicted velocity vector v;

updating the preliminary primary transfer function, based on the predicted momentum vector m and the predicted velocity vector v;

updating the plurality of predicted second noise based on the updated preliminary primary transfer function;

The preliminary primary transfer function may be a weight vector.

Updating the plurality of predicted second noise may comprise updating the plurality of predicted second data based on the updated preliminary primary transfer function.

The step of the neural network optimizing the preliminary primary transfer function may comprise setting a predetermined value for each of following parameters for optimization:
a step size μ, and
two forgetting factors β1 and β2.

The step of the neural network optimizing the preliminary primary transfer function may comprise setting an initial value for each of following parameters for optimization:
the momentum vector m,
the velocity vector v,
a time step t, and
the weight vector w.

The step of calculating the primary transfer function may comprise the neural network optimizing a preliminary primary transfer function for each of the plurality of operating conditions.

Prior to the step of estimating at least one second noise, the method may comprise determining a current operating condition of the vehicle, and using the primary transfer function optimized for the current operating condition of the vehicle for estimating the at least one second noise.

It is advantageous as the primary transfer function may be calculated not only for each second location, but also for each operating condition. Depending on the current operating condition of the vehicle, only the primary transfer function optimized for the current operating condition may be activated for estimating the second noise. The primary transfer functions optimized for those operating conditions different from the current operating condition may be deactivated and not used for estimating the second noise.

According to a second aspect, there is provided a system for reducing noise within a cabin of a vehicle. The system comprises:

at least one error sensor configured to measure at least one first noise at a first location within the cabin, wherein the at least one error sensor is provided at the first location; and

a control circuit configured to select at least one sound zone from a plurality of sound zones within the cabin for reducing noise in said at least one sound zone, based on a presence of a driver and passenger(s) within the cabin, wherein the selected at least one sound zone corresponds to at least one zone occupied by the driver and/or passenger(s);

wherein the control circuit is configured to estimate at least one second noise that would have been measured at a second location within the selected at least one sound zone, based on a primary transfer function describing a primary acoustic path from the first location to the second location;

wherein the system further comprises:

at least one sound transducer configured to generate at least one secondary noise for reducing the at least one second noise that would have been measured at the second location.

According to a third aspect, there is provided a non-transitory computer readable recording medium having computer readable program code recorded thereon which when executed on a device having processing capability is configured to cause the system of the second aspect to perform the method of the first aspect.

### BRIEF DESCRIPTION OF THE DRAWINGS

FIG. 1 illustrates a schematic view of a car having an ANC system.

FIG. 2 illustrates a schematic view of a car for calculating a secondary transfer function.

FIG. 3 illustrates a schematic view of a car for calculating a primary transfer function.

FIGS. 4a and 4b are two examples of the second location(s) of the selected sound zone(s) within a car.

FIG. 5a is a flowchart of an example of estimating a second error signal.

FIG. 5b is an example of a system for reducing noise.

FIG. 6 illustrates diagrams of noise reduction simulation.

FIG. 7 illustrates diagrams of noise reduction simulation.

### DESCRIPTION OF EMBODIMENTS

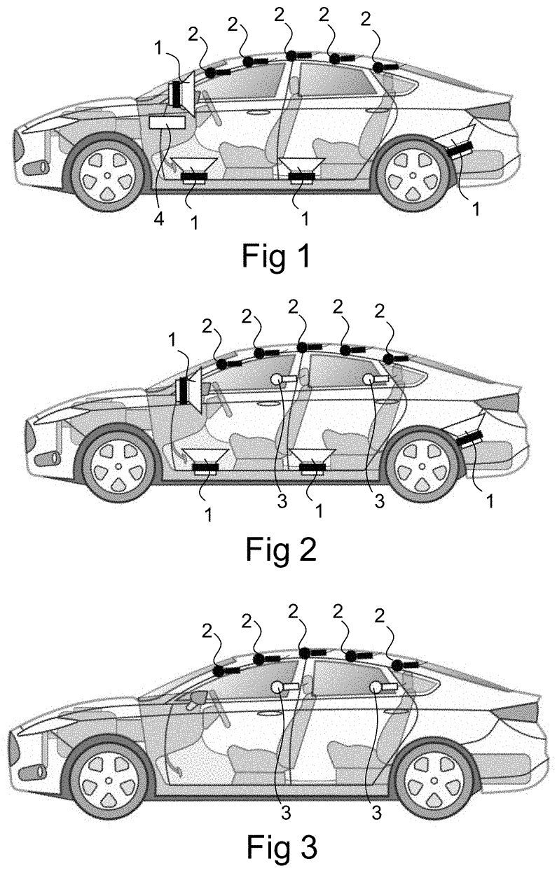

In connection with FIG. 1, the system for reducing noise within a cabin of a vehicle will be discussed in detail.

The system can be used for reducing noise within a cabin of a car, as shown in FIG. 1.

The system can be used for reducing noise within a cabin of a truck, a train, a buss, an airplane, and any other types of vehicles.

The system may be an ANC or an ARNC system.

In FIG. 1, the system comprises four sound transducer 1, five error sensors 2 and a control unit 4.

The numbers of the sound transducers 1, and the error sensors 2 shown in the figures are only illustrative examples.

The system may comprise at least one reference sensor (not shown) for measuring a primary noise at a primary noise source. The reference sensor may generate a reference signal representing the primary noise measured at the primary noise source.

The reference sensor may be an accelerometer, a microphone, or a tachometer.

The reference sensor may be any other type of sensors for characterising an excitation of an acoustic field or an excitation of a structure.

The reference sensor may be provided closed to or at a noise source. Depending on the different noise sources, the reference sensor may be provided at different places. For example, the reference sensor may be placed on a car chassis around the wheels of the car.

The reference sensor may be placed within the cabin.

The primary noise may be a road noise, generated by e.g., an interaction of a vehicle with a road through tires. The primary noise may also be any other types of noises, such as a wind noise or an engine noise.

The system may comprise at least two sound transducers 1 provided at two different locations.

The sound transducer 1 may be an actuator, such as a loudspeaker or a vibrating panel, e.g., an active panel.

The system may comprise at least two error sensors 2 provided at two different locations within the cavity.

The error sensor 2 may be, e.g., a microphone. The error sensors 2 may be placed close to an ear or head position of the driver or the passengers within the cabin. As illustrated in FIG. 1, the error sensors 2 are mounted on a headliner of the cabin, which is close to the head of the driver and the passengers.

Each error sensor 2 is configured to measure a first noise at a first location where said error sensor is provided.

Each error sensor 2 may generate a first error signal representing the first noise measured by said error sensor.

The first noise may be a superposition of the primary noise and the secondary noise at the first location.

Although the error sensors 2 may be placed close to an ear or head position of a person, the noise cancellation is not optimal for the person due to the distance between the ear/head of the driver or passengers and the error sensors on the headliner. Thus, the second position (i.e. the position of a virtual microphone) may be selected to be the exact position that the noise reduction should be most effective.

The second position is a position different from the first position. No error sensor is provided at the second position.

The reference sensor, the error sensors 2 and sound transducers 1 may be respectively connected to the control unit 4. The reference sensor, the error sensors 2, the sound transducers 1 and the control unit 4 may be respectively connected via a wire or wirelessly.

The control unit 4 may be an entity inside the car, as shown in FIG. 1, as a part of a vehicle system. Alternatively, the control unit 4 may be a cloud based control unit.

The control unit 4 may comprise a control circuit. The control circuit may be a processing circuit, such as a central processing unit (CPU), microcontroller, or microprocessor.

The control circuit is configured to estimate the second noise that would have been measured at the second location by an error sensor which is not provided at the second location (i.e. a virtual microphone). The estimation is based on the primary transfer function describing a primary acoustic path from the first location to the second location.

The control circuit may be configured to estimate the second error signal representing the second noise that would have been measured at the second location.

The second noise may be a superposition of the primary noise and the secondary noise at the second location.

The step of estimating the second noise comprises calculating the primary transfer function by machine learning, which will be discussed later in connection with FIG. 3.

The control unit 4 may comprise a memory. The processing circuit may be configured to execute program codes stored in the memory, in order to carry out functions and operations of the control unit 4.

The memory may be one or more of a buffer, a flash memory, a hard drive, a removable medium, a volatile memory, a non-volatile memory, a random access memory (RAM), or another suitable device. In a typical arrangement, the memory may include a non-volatile memory for long term data storage and a volatile memory that functions as system memory for the control unit 4. The memory may exchange data with the processing circuit over a data bus. Accompanying control lines and an address bus between the memory and the processing circuit also may be present.

Functions and operations of the control unit 4 may be embodied in the form of executable logic routines (e.g., lines of code, software programs, etc.) that are stored on a non-transitory computer readable medium (e.g., the memory) of the control unit 4 and are executed by the processing circuit.

Furthermore, the functions and operations of the control unit 4 may be a stand-alone software application or form a part of a software application that carries out additional tasks related to the control unit 4. The described functions and operations may be considered a method that the corresponding system is configured to carry out. Also, while the described functions and operations may be implemented in software, such functionality may as well be carried out via dedicated hardware or firmware, or some combination of hardware, firmware and/or software.

The control unit 4 may comprise a user interface. The user interface may be configured to output data and to receive input data from one or several input devices. The output data may be an amplitude of the estimated second noise. The input data may be the second position selected by a user. The input device may be a computer mouse, a keyboard, a track ball, a touch screen, or any other input device. The user interface may send the received data to the processing circuit for further processing.

The control circuit may be configured to generate a control signal by executing an adaptive filtering algorithm. The control circuit may be configured to update an adaptive filter based on the primary noise and the estimated second noise by executing the adaptive filtering algorithm. The control circuit may be configured to generate the control signal by filtering the primary noise by the updated adaptive filter. The sound transducer 1 may generate the secondary noise, in response to the control signal for cancelling the primary noise at the second location.

In connection with FIG. 2, the calculation of the secondary transfer function will be discussed in detail.

The calculation of the secondary transfer function may need a calibration. The calibration may be performed prior to the using of the system. That is, the system is not running for cancelling noises during calibration.

The calibration may be done when there is no primary noise. For example, the vehicle may be stationary during calibration.

The system comprises the error sensors 2 and the sound transducers 1 as the example of FIG. 1. Additionally, at least one monitor sensor 3 may be provided at one or more second locations during calibration. In FIG. 2, two monitor sensors 3 are provided at two second locations, e.g., the head positions of the driver and one rear row passenger.

The monitor sensor 3 may measure the noise for calibration at the second location.

The sound transducer 1 may generate a noise for calibration.

The noise for calibration may be a broadband noise. The broadband noise may be any one or any combination of a white, a pink, and a brown noise.

The error sensor 2 may measure the noise for calibration at the first location.

The secondary transfer function may be calculated based on the noise for calibration, and the measured noises for calibration at the first and second location, respectively.

The provided monitor sensors 3 may be removed from the second locations after the calibration.

The monitor sensors 3 may be of a same type of the error sensors 2.

The secondary transfer function may be stored in a local memory, e.g., the memory of the control unit 4, or in a remote server.

The step of estimating a second noise may comprise estimating the second noise based on the first noise, the secondary noise, the primary transfer function, and the secondary transfer function.

The step of estimating a second noise may comprise estimating the second error signal based on the first error signal, the secondary noise, the primary transfer function, and the secondary transfer function.

In connection with FIG. 3, the calculation of the primary transfer function will be discussed in detail.

In prior art, the primary transfer function used for estimating the second noise or the second error signal can be calculated using the H1 or H2 transfer function estimated in the frequency domain and performing an inverse Fourier transform to retrieve Finite Impulse Response (FIR) filters modelling the primary transfer function. The primary transfer function may be modelized by a known method.

A LMS method can be used to converge the FIR filters using a LMS method.

However, the primary transfer function calculated by the prior art methods are not accurate enough.

In the invention, the primary transfer function is calculated by machine learning which can improve the accuracy of the estimation of the primary transfer function.

The calculation of the primary transfer function may need a calibration. The calibration may be performed prior to the using of the system. That is, the system is not running for cancelling noises during calibration.

The system comprises the error sensors 2 as the example of FIG. 1. Additionally, at least one monitor sensor 3 may be provided at one or more second locations for calibration.

In FIG. 3, two monitor sensors 3 are provided at two second locations, e.g., the head positions of the driver and one rear row passenger.

The calibration may be done when there is no sound transducer 1 provided or the sound transducer 1 of the system is deactivated.

The calibration needs the first and second noises measured by the error sensor 2 and the monitor sensor 3, respectively. The car under test may be moving on a road for generating the primary noise to be cancelled.

When exposed to the primary noise, the error sensor 2 may measure the first noise at the first location. The monitor sensor 3 may measure the second noise simultaneously at the second location. The measured first and second noises may be a recording of the primary noise respectively captured by the error sensor and monitor sensor.

Further, the calibration needs the first and second noises measured under different operating conditions. Since the primary noise may be a road noise, a wind noise, or an engine noise, the different primary noises may be caused by driving the vehicle under different operating conditions. Examples of the different operating conditions may be, driving the car at different types of road surfaces, driving the car with different types of wheels, driving the car at different speeds, driving the car at different whether conditions, etc.

The measurement may be repeated for the different operating conditions, such that the following noises can be collected by the error sensor 2 and the monitor sensor 3:

i) the plurality of first noises respectively measured at the first location, under the plurality of operating conditions, and

ii) the plurality of second noises respectively measured at the second location, under the plurality of operating conditions.

The plurality of first noises and the plurality of second noises have a one-to-one corresponding relationship. In other words, the plurality of first noises and the plurality of second noises may be considered as a plurality of pairs of noises, each pair of noises comprising a first noise and a second noise. The first noise and the second noise of each pair of noises may be collected by one measurement under one operating condition. In this way, the primary transfer function can be predicted by using each of the first noise and its corresponding second noise (the second noise of the same pair of noises).The recordings of the plurality of first noises and the plurality of second noises may be used as input for performing machine learning.

A plurality of first data representing the plurality of first noises, and a plurality of second data representing the plurality of second noises may be used as input for performing machine learning.

The neural network predicts a plurality of predicted second noises based on the plurality of first noises and a preliminary primary transfer function. A difference between the plurality of predicted second noises and the plurality of second noises is an error of prediction.

The neural network may predict a plurality of predicted second data based on the plurality of first data and the preliminary primary transfer function. A difference between the plurality of predicted second data and the plurality of second data may be the error of prediction.

The neural network optimizes the preliminary primary transfer function for reducing the error of prediction. The optimized preliminary primary transfer is the calculated primary transfer function.

The neural network may repeat the step of predicting a plurality of predicted second noises or the step of predicting a plurality of predicted second data, and the step of optimizing the preliminary primary transfer function, until the error of prediction is less than a predetermined threshold.

The deep learning process performed by the neural network will be discuss in detail.

For simplification, the following example uses a system having one reference sensor, one error sensor and one sound transducer, i.e. a Single-Input-Single-Output (SISO) system. When there is a plurality of reference sensors, and/or a plurality of error sensors, and/or a plurality of sound transducers, the same principles are applicable in the corresponding Multi-Input-Single-Output (MISO) system or Multi-Input-Multi-Output (MIMO) system.

The following notations are used in the example:
ā refers to a vector in the time domain;
Ā refers to a corresponding vector in the frequency domain;
A̅ refers to a corresponding matrix;
ā *b̅ refers to a linear convolution of vectors ā and b̅;
1̅_{N} denotes a unit vector of size N.

The input to the neural network may include x̅, a vector (time domain) of the first data measured by the error sensor 2. The time t is an index, ranging from t=0 (the initial step) to t=n−1 (the nth step). The size of x̅ is n corresponding to n time steps.

The primary transfer function can be modelized by 1D convolution layers of the neural network as an FIR filter. The FIR filter coefficients are learnable during the learning process. The FIR filter coefficients w̅ may be a vector. The size of the vector w̅ is TAPS.

The input to the neural network may include y̅, a vector of the second data measured by the monitor microphone 3. The size of y̅ is n−TAPS+1, corresponding to time steps TAPS−1 to n−1.

Hereinafter, the number “n−TAPS+1” is represented by “L”.

The predicted second data may be a predicted vector ŷ, wherein ŷ=w̅ *x̅.

The error of prediction is defined as a vector ē, wherein ē=y̅−ŷ.

The input x̅ in the frequency domain X̅ is defined as follows by Discrete Fourier Transform (DFT):

$$\overline{X} = [ \begin{matrix}1 & 1 & 1 & … & 1 \\ 1 & ω & {ω}^{2} & … & {ω}^{n - 1} \\ 1 & {ω}^{2} & {ω}^{4} & … & {ω}^{2 ( n - 1 )} \\ ⋮ & ⋮ & ⋮ & ⋱ & ⋮ \\ 1 & {ω}^{n - 1} & {ω}^{2 ( n - 1 )} & … & {ω}^{{( n - 1 )}^{2}}\end{matrix} ] [ \begin{matrix}{x}_{0} \\ {x}_{1} \\ {x}_{2} \\ ⋮ \\ {x}_{n - 1}\end{matrix} ] = \overline{\overline{Ω}} \overline{x} ω = {e}^{- \frac{2 i π}{n}}$$

The goal of the machine learning is to reduce the error of prediction e. In other words, the goal is to optimize:

$$Loss ( \overline{y} , \hat{\overline{y}} ) = \frac{1}{L} {\overline{1}}_{L} . \vert \overline{Y} - \hat{Y} \vert = \frac{1}{L} {\overline{1}}_{L} . \vert \overline{E} \vert$$

Firstly, there is provided that:

$$\frac{\partial \hat{\overline{y}}}{\partial \overline{w}} = \frac{\partial }{\partial \overline{w}} {\overline{w}}^{*} \overline{x} = \overline{\overline{{x}^{↼}}}$$

It is known that:

$$\overline{\overline{{x}^{↼}}} = [ \begin{matrix}{x}_{0} & {x}_{1} & … & {x}_{TAPS - 1} \\ {x}_{1} & {x}_{2} & … & {x}_{TAPS} \\ ⋮ & ⋮ & ⋱ & ⋮ \\ {x}_{L - 1} & {x}_{L} & … & {x}_{n - 1}\end{matrix} ] , L = n - TAPS + 1.$$

Then, there is:

$$L \frac{\partial Loss}{\partial \overline{E}} = \frac{\partial }{\partial \overline{E}} {\overline{1}}_{L} . \vert \overline{E} \vert = \frac{\overline{E}}{\vert \overline{E} \vert}$$

and:

$$\frac{\partial \overline{E}}{\partial e} = {\overline{\overline{Ω}}}^{*}$$

Finally, by applying the chain rule, there is provided:

$$\frac{\partial L o s s}{\partial \overline{w}} = \frac{\partial L o s s}{\partial \overline{E}} \frac{\partial \overline{E}}{\partial e} \frac{\partial e}{\partial \hat{\overline{y}}} \frac{\partial \hat{\overline{y}}}{\partial \overline{w}}$$

$$\frac{\partial L o s s}{\partial \overline{w}} = \frac{- 1}{L} \frac{\overline{\overline{Ω}} \overline{e} {\overline{\overline{Ω}}}^{*}}{\vert \overline{E} \vert} \overline{\overline{{x}^{↼}}}$$

The FIR filter coefficients w̅ may be updated by the following equation, wherein the Fast Fourier Transform (FFT) loss is the default loss:

$${\overline{w}}_{t + 1} = {\overline{w}}_{t} - \frac{μ}{L} \frac{\overline{\overline{Ω}} \overline{e} {\overline{\overline{Ω}}}^{*}}{\vert \overline{E} \vert} \overline{\overline{{x}^{↼}}} = {\overline{w}}_{t} - μ [ iFFT \frac{\overline{E}}{\vert \overline{E} \vert} ) \overline{\overline{{x}^{↼}}} ]$$

The FIR filter coefficients w̅ may be updated by the following equation, wherein the Mean Squared Error (MSE) loss is the default loss:

$${\overline{w}}_{t + 1} = {\overline{w}}_{t} - \frac{μ}{L} \overline{e} . \overline{\overline{{x}^{↼}}}$$

The learning loop will be discussed in detail by using an Adaptive Moment Estimation (ADAM) optimizer as an example. The Adaptive Moment Estimation (ADAM) optimizer may be used for optimizing FIR filter coefficients w in the learning loop.

Each of two forgetting factors β₁, β₂ may be set to a predetermined value.

A step size μ may be set to a predetermined value.

A vector of momentum m̅ and a vector of velocity ν̅ may be initialized as two zero vectors of size TAPS.

In an initial learning loop, t may be set to “0”.

For each additional learning loop, the value of t may be added by “1”. In other words, t will be equal to 1, 2, . . . , n−1, respectively, in the following learning loops. For each learning loop, the following steps may be executed.

The predicted second data ŷ may be calculated based on the FIR filter coefficients w and the first data x̅, by:

ŷ=w̅ₜ*x̅

The error of prediction Ē may be calculated by:

Ē=FFT(y̅−ŷ)

A gradient of the error of prediction may be calculated by:

$$\frac{\partial L o s s}{\partial {\overline{w}}_{t}} = iFFT ( \frac{\overline{E}}{\vert \overline{E} \vert} ) \overline{\overline{{x}^{↼}}}$$

The vector of momentum m̅ and the vector of velocity ν̅ may be updated by:

$${\overline{m}}_{t + 1} = {β}_{1} {\overline{m}}_{t} + ( 1 - {β}_{1} ) \frac{\partial L o s s}{\partial {\overline{w}}_{t}}$$

$${\overline{v}}_{t + 1} = {β}_{2} {\overline{v}}_{t} + {( 1 - {β}_{2} ) [ \frac{\partial L o s s}{\partial {\overline{w}}_{t}} ]}^{2}$$

$$\hat{\overline{m}} = \frac{{\overline{m}}_{t + 1}}{( 1 - {β}_{1} )}$$

$$\hat{\overline{v}} = \frac{{\overline{v}}_{t + 1}}{( 1 - {β}_{2} )}$$

The FIR filter coefficients w̅ may be updated, by:

$${\overline{w}}_{t + 1} = {\overline{w}}_{t} - μ \frac{\hat{\overline{m}}}{\sqrt{\hat{\overline{v}}} + ϵ} ,$$

wherein ϵ is a regularization term.

The neural network may optimize a primary transfer function for each of the plurality of operating conditions. Prior to the step of estimating a second noise, a current operating condition of the vehicle may be determined. The optimized primary transfer function for the current operating condition of the vehicle may be used for estimating the second noise.

The calculated primary transfer function may be stored in a local memory, e.g., the memory of the control unit 4, or in a remote server.

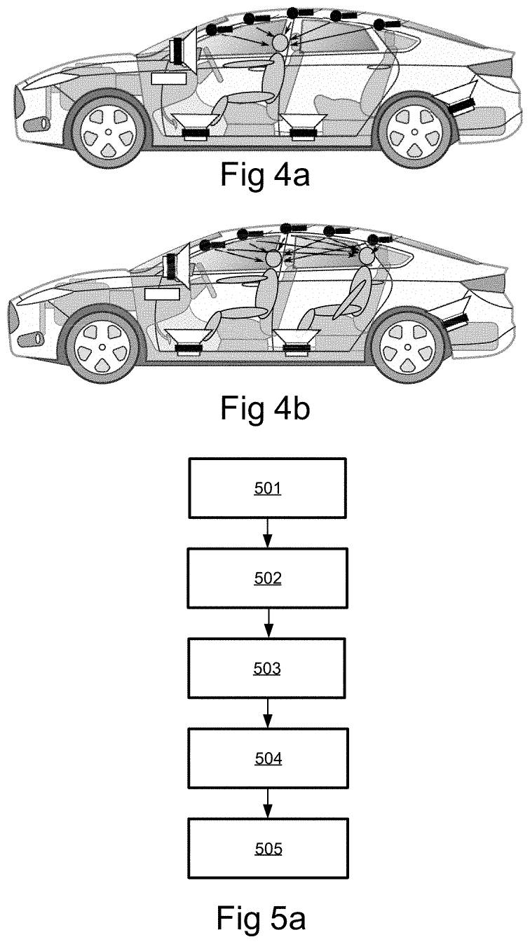

In connection with FIGS. 4a and 4b, examples of the second location will be discussed in detail.

In reality, there are typically a plurality of second locations within the cabin, where noises reduction is needed. For example, for a car of five seats, there may be at least five second locations corresponding to the head/ear position of the person that would sit on each of the five seats.

The system may estimate a second noise that would have been measured at each of these five second locations, in order to cancel the noises at these locations.

FIG. 4a is an example of a car having only a driver and no passengers. There may be a plurality of sound zones respectively corresponding to at least one of the driver and passenger(s) that would sit within the car. For example, there may be five sound zones respectively corresponding to the head/ears position of the driver, the front passenger, and the three rear passengers.

The sound zone corresponding to the driver may be selected. The second location of the selected sound zone may be the head/ears position of the driver. In other words, the sound zones corresponding to the four passengers (both front and rear) may be unselected.

That is, the head/ears positions of the four passengers (the second locations of the unselected sound zones) may be ignored as no persons are present at these seats. This may enhance the noise reduction perceived by the driver.

FIG. 4b is an example of the same car having the driver and one rear row passenger. The sound zone(s) corresponding to the driver and the rear row passenger may be selected. The second locations of the selected sound zone(s) may be the head/ears position of the driver and the head/ears position of the rear row passenger. In other words, the sound zones corresponding to the other three passengers (both front and rear) may be unselected. That is, the head/ears positions of the other three passengers (the second locations of the unselected sound zones) may be ignored. This may enhance the noise reduction perceived by the driver and the rear row passenger.

One or more sound zones may be selected from the plurality of sound zones.

The selection of sound zone(s) (the second location(s)) may be transmitted to the adaptive filtering algorithm of the system. The adaptive filtering algorithm may only activate the selected sound zone(s) or the selected second location(s) (the selected virtual microphone(s)). Alternatively, the adaptive filtering algorithm may deactivate the unselected sound zone(s) or the unselected second location(s) (the unselected virtual microphone(s)).

The selection of the sound zone(s) (the second location(s)) may be done prior to the estimation of a second noise at the second location of each sound zone of the plurality of sound zones. For example, in the example of FIG. 4a, the system may only estimate the second noise at the second location of the selected sound zone, i.e. at the head/ears position of the driver. In the example of FIG. 4b, the system may only estimate the second noise at the second location of the selected sound zone, i.e. at the head/ears positions of both the driver and the rear row passenger.

The selection of sound zone(s) (the second location(s)) may be done after the estimation of a second noise at the second location of each sound zone of the plurality of sound zones. For example, in the example of FIG. 4a, the system may only use the estimated second noise at the second location of the selected sound zone, i.e. at the head/ears position of the driver, for updating the adaptive filter. The estimated second noises of the second locations of the unselected sound zones may not be used for updating the adaptive filter. In the example of FIG. 4b, the system may only use the estimated second noise at the second locations of the selected sound zone, i.e. the head/ears positions of both the driver and the rear row passenger. The estimated second noise of the second locations of the unselected sound zones may not be used for updating the adaptive filter.

The selection of the sound zone(s) (the second location(s)) may be done manually.

The driver or the passengers may manually select the sound zone(s) (the second location(s)). For example, in the example of FIGS. 4a and 4b, the driver may manually select to only reduce noise for the sound zone corresponding to the driver (the second location of the selected sound zone would be the head/ears position of the driver). The rear row passenger of the example of FIG. 4b may manually select to reduce noise for the sound zone corresponding to himself (the second location of the selected sound zone would be the head/ears position of the rear row passenger).

Alternatively, or in combination, the selection of the sound zone(s) (the second location(s)) may be done automatically, based on information retrieved from an existing vehicle system. The existing vehicle system may keep track of the driver and/or passengers within the cabin.

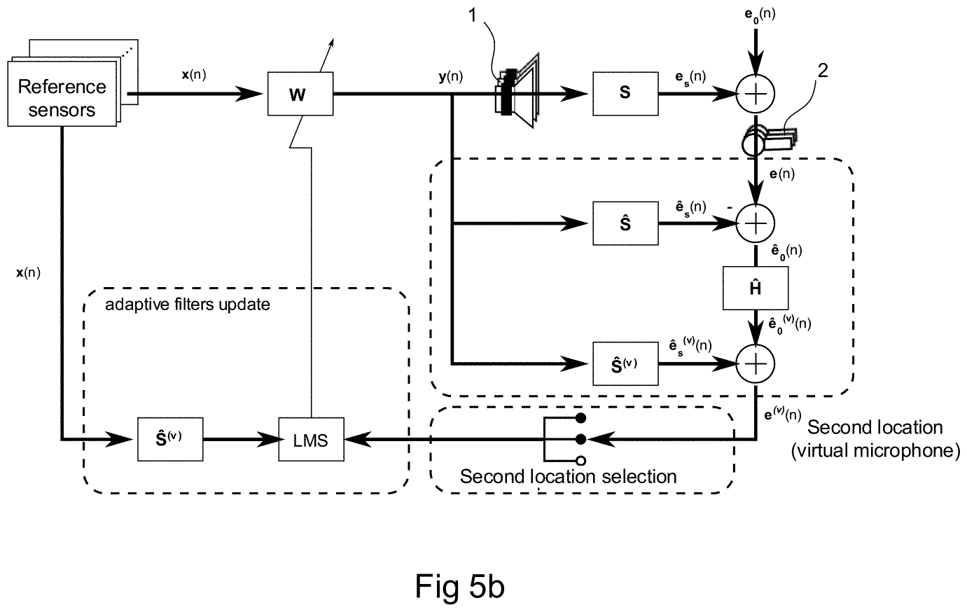

In connection with FIGS. 5a and 5b, the estimation of the second error signal noise will be discussed in detail.

FIG. 5b is an example of a system for reducing noise using an adaptive filtering algorithm. The system comprises a plurality of reference sensors, a plurality of error sensors 2, and a plurality of sound transducer 1. For simplification, one reference sensor, one error sensor 2, and one sound transducer 1 is used for discussing the estimation of the second noise.

The reference sensor may be configured to generate the reference signal x(n) representing a primary noise measured at a primary noise source.

The error sensor 2 may be configured to generate the first error signal e(n) representing the first noise measured by the error sensor 2.

The second error signals ê^{(v)}(n) representing the second noise that would have been measured at the second location may be estimated according to the steps 501-505 of FIG. 5a.

Step 501. A secondary signal êₛ(n) representing the secondary noise that would have been measured at the first location may be calculated.

The secondary signal êₛ(n) may be calculated based on the control signal y(n) driving the sound transducer and the secondary transfer function Ŝ from the sound transducer to the first location.

The secondary signal êₛ(n) may be calculated by convolution of the control signal y(n) with the secondary transfer function Ŝ from the sound transducer to the first location.

Step 502. A primary signal ê₀(n) representing the primary noise that would have been measured at the first location may be calculated.

The primary signal ê₀(n) may be calculated based on the first noise and the secondary signal êₛ(n).The primary signal ê₀(n) may be calculated based on the first error signal e(n) and the secondary signal êₛ(n).

The primary signal ê₀(n) at the first location may be calculated by removing the estimated secondary signal êₛ(n) at the first location of step 501 from the first error signal e(n).

Step 503. A primary signal ê₀^{(v)}(n) representing the primary noise that would have been measured at the second location (virtual microphone) may be calculated.

The primary signal ê₀^{(v)}(n) may be calculated based on the primary signal ê₀(n) at the first location of step 502 and the primary transfer function Ĥ.

The primary signal ê₀^{(v)}(n) may be calculated by convolution of the primary signal ê₀(n) of step 502 and the primary transfer function Ĥ.

Step 504. A secondary signal êₛ^{(v)}(n) representing the secondary noise that would have been measured at the second location may be calculated.

The secondary signal êₛ^{(v)}(n) may be calculated based on the control signal y(n) and the secondary transfer function Ŝ^{(v)} from the sound transducer 1 to the second location.

The secondary signal êₛ^{(v)}(n) may be calculated by convolution of the control signal y(n) with the secondary transfer function Ŝ^{(v)} from the sound transducer 1 to the second location.

Step 505. A second error signal êₛ^{(v)}(n) may be calculated, based on the primary signal ê₀^{(v)}(n) of step 503 and the secondary signal êₛ^{(v)}(n) of step 504.

The calculated second error signal ê^{(v)}(n) may represent the second noise that would have been measured at the second location.

The second error signal ê^{(v)}(n) may be calculated by summing the primary signal ê₀^{(v)}(n) at the second location of step 503 and the secondary signal ê_{S}^{(v)}(n) at the second location of step 504.

When there are multiple second locations, the second location may be selected after or prior to the estimation of the second noise or the second error signal ê^{(v)}(n).

An adaptive filter may be a system having a transfer function controlled by variable parameters and a means to adjust those parameters according to an optimization algorithm. The adaptive filter may use feedback to refine its transfer function. Thus, the adaptive process is a closed loop process. The goal behind the closed loop process is to update the adaptive filter until the error signal is minimized. The Least Mean Squares (LMS) filter is an example of the adaptive filter.

The adaptive filtering algorithm is a known algorithm for updating the adaptive filter in order to reduce the estimated second noise and/or the second error signal that would have been measured at the second location.

An adaptive filter may be updated based on the reference signal x(n) and the estimated second error signals ê^{(v)}(n) by executing the adaptive filtering algorithm.

The adaptive filter may be updated based on the reference signal x(n), the secondary transfer function Ŝ^{(v)} from the sound transducer 1 to the second location, and the second error signals ê^{(v)}(n) by executing the adaptive filtering algorithm.

The adaptive filtering algorithm may be a filtered-x least mean square, FxLMS, algorithm.

The FxLMS algorithm may be a MIMO, MISO, SISO FxLMS algorithm.

The FxLMS algorithm may be a subband FxLMS algorithm. Here, a subband is a portion of the frequency band of the adaptive filter.

The adaptive filter may be updated either in the time-domain (e.g., by a time domain FxLMS algorithm) or in the frequency domain (e.g., by a frequency domain FxLMS algorithm).

The adaptive filter may be updated in the subbands, when the adaptive filtering algorithm is a subband FxLMS algorithm.

The control signal y(n) for driving the sound transducer may be generated by filtering the reference signal x(n) by the updated adaptive filter.

The sound transducer 1 may be configured to generate a secondary noise, in response to the control signal y(n), for cancelling the primary noise at the second location.

The first and second noise may be a superposition of the primary noise and the secondary noise at the first and the second location, respectively.

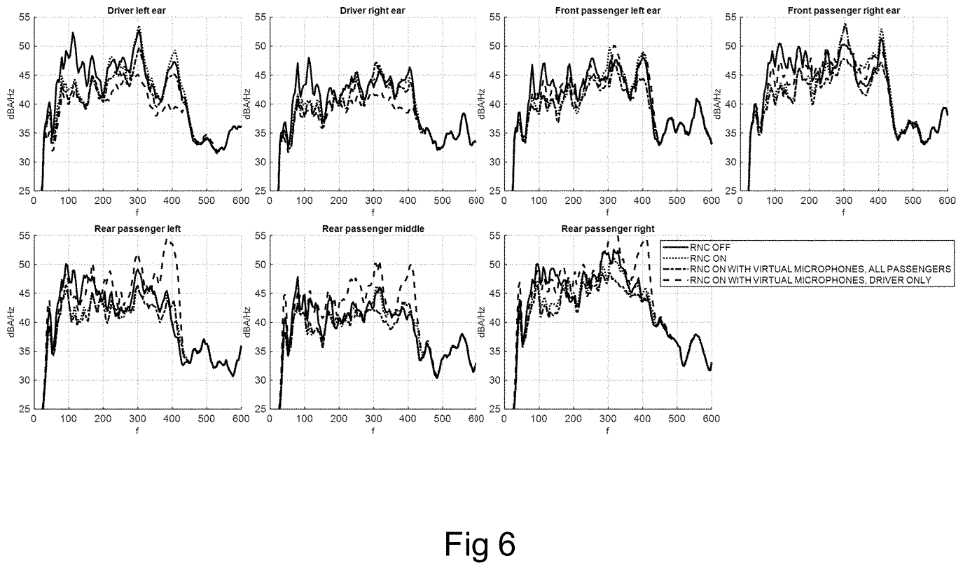

FIG. 6 illustrates diagrams of noise reduction simulation results visualising a simulated power spectral density at different locations within the car cabin.

The power spectral densities are simulated based on recorded signals. The recorded signals used in the simulation are recorded in a premium Sport Utility Vehicle (SUV) when moving at a speed of 80 km/h.

The SUV is a car of five seats respectively for a driver, a front passenger, a rear left passenger, a rear middle passenger, and a rear right passenger.

A Power Spectral Density (PSD) is the measure of a power of a signal versus frequency. The simulated power spectral density of a frequency range of 0 to 600 Hz is displayed in the diagrams.

The PDS are simulated at seven different locations. The seven locations are the left ear of the driver, the right ear of the driver, the left ear of the front passenger, the right ear of the front passenger, the head of the rear left passenger, the head of the rear middle passenger, and the head of the rear right passenger, respectively.

For each position, the simulated power spectral density has four different settings:
1) no active noise cancellation is activated;
2) a traditional active noise cancellation is activated for reducing noises at an error sensor;
3) the active noise cancellation is activated for reducing noises at the ear/head positions of all the passengers (as the second locations of the selected sound zone(s)), according to the invention; and
4) the active noise cancellation is activated for reducing noises at only the ears positions of the driver (as the second locations of the selected sound zone(s)), according to the invention.

The setting 1) is when there is no active noise control activated for reducing noises within the cabin.

The setting 2) is when a traditional ANC or RNC system is used for noise reduction within the cabin using the feedback of the provided error sensors.

The setting 3) is when the system of the invention is implemented, and the second locations (virtual microphones) of the selected sound zone(s) are the ear/head positions of all the passengers.

The setting 4) is when the system of the invention is implemented, and the second locations (virtual microphones) of the selected sound zone(s) are the ears positions of only the driver.

In the diagrams, using the simulation results under setting 1) as a reference, it can be seen that the simulated power spectral density under the setting 2) is lower at the seven locations in a limited frequency range.

Further, it can be seen that the simulated power spectral density under the setting 3) and 4) according to the invention are much lower than the simulated power spectral density under the settings 1) or 2), especially in a frequency range of 200 to 450 Hz.

Moreover, the noise reduction performance for the driver is much improved when only the driver sound zone is selected wherein the ears positions of the driver are the second locations (virtual microphones) under the setting 4). However, the improved noise reduction performance for the driver is achieved at the cost of a degradation of the noise reduction performance at other positions. When there is no passenger in the cabin, this configuration may greatly improve the noise reduction for the driver.

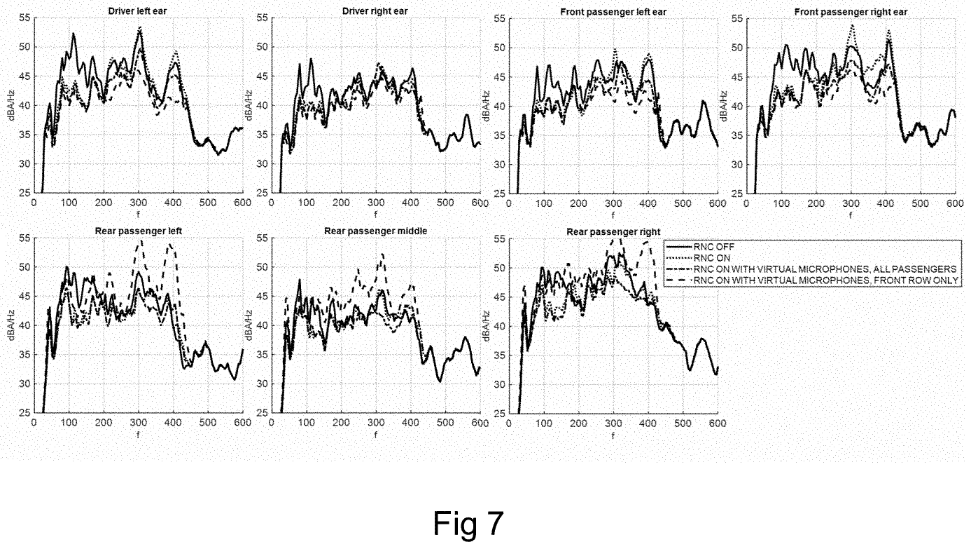

FIG. 7 illustrates diagrams of noise reduction simulation results visualising the simulated power spectral density at the same seven locations within the car cabin, as in FIG. 6.

The simulations are performed under the same conditions as that of FIG. 6. The only difference is that the setting 4) of FIG. 6 is replaced by the following setting 5):
5) the active noise cancellation is activated for reducing noises at the positions of the ears of the front row occupants, i.e. the driver and the front passenger, (as the second locations of the selected sound zone(s)), according to the invention.

The setting 5) is when the system of the invention is implemented, and the second locations (virtual microphones) of the selected sound zone(s) are the ears positions of both the driver and the front passenger.

Similar to FIG. 6, the simulated power spectral density under the setting 3) and 5) according to the invention are much lower than the measured power spectral density under the settings 1) or 2), especially in a frequency range of 200 to 450 Hz.

Further, it can be seen that the noise reduction performance for the driver and the front passenger is much improved when only the ears positions of the driver and the front passenger are selected as the second locations. The improved noise reduction performance for the driver and the front passenger are achieved at the cost of a degradation of the noise reduction performance at other positions.

The person skilled in the art realizes that the present invention by no means is limited to the examples described above. On the contrary, many modifications and variations are possible within the scope of the appended claims. For example, the number, the type, and the arrangement of the error sensors may be different. Such details are not considered to be an important part of the invention, which relates to the method and system for reducing noise within a cabin of a vehicle.

1. A method for reducing noise within a cabin of a vehicle comprising at least one error sensor and at least one sound transducer, the method comprising:
measuring at least one first noise at a first location within the cabin by the at least one error sensor, wherein the at least one error sensor is provided at the first location;
selecting at least one sound zone from a plurality of sound zones within the cabin for reducing noise in said at least one sound zone, based on a presence of a driver and passenger(s) within the cabin, wherein the selected at least one sound zone corresponds to at least one zone occupied by the driver and/or passenger(s);
estimating at least one second noise that would have been measured at a second location within the selected at least one sound zone, based on a primary transfer function describing a primary acoustic path from the first location to the second location; and
generating at least one secondary noise for reducing the at least one second noise that would have been measured at the second location by the at least one sound transducer.

2. The method as claimed in claim 1, wherein the step of estimating at least one second noise comprises:
calculating the primary transfer function by machine learning, comprising:
providing a plurality of first noises respectively measured at the first location under a plurality of operating conditions;
providing a plurality of second noises respectively measured at the second location under the plurality of operating conditions;
inputting the plurality of first noises and the plurality of second noises to a neural network;
predicting a plurality of predicted second noises based on the plurality of first noises and a preliminary primary transfer function by the neural network, wherein a difference between the plurality of predicted second noises and the plurality of second noises is an error of prediction;
optimizing the preliminary primary transfer function for reducing the error of prediction by the neural network;
wherein the optimized preliminary primary transfer is the calculated primary transfer function.

3. The method as claimed in claim 2, wherein the step of estimating at least one second noise comprises:
repeating the step of the neural network predicting a plurality of predicted second noises and the step of the neural network optimizing the preliminary primary transfer function, until the error of prediction is less than a predetermined threshold.

4. The method as claimed in claim 2, wherein the step of calculating the primary transfer function comprises:
optimizing a preliminary primary transfer function for a second location within each sound zone of the plurality of sound zones by the neural network;
wherein the method further comprises:
using the primary transfer function optimized for the second location of the selected at least one sound zone for estimating the at least one second noise.

5. The method as claimed in claim 1, wherein the step of estimating at least one second noise comprises:
calculating a secondary transfer function describing a secondary acoustic path of the at least one secondary noise from the at least one sound transducer to each of the first and second location, and
estimating the at least one second noise based on the at least one first noise, the at least one secondary noise, the primary transfer function, and the secondary transfer function.

6. The method as claimed in claim 5, wherein the step of calculating a secondary transfer function comprises:
providing at least one monitor sensor at the second location,
generating at least one noise for calibration by the at least one sound transducer,
measuring the at least one noise for calibration at the first location by the at least one error sensor,
measuring the at least one noise for calibration at the second location by the at least one monitor sensor,
calculating the secondary transfer function based on the at least one noise for calibration, and the measured noises for calibration at the first and second location, respectively, and
removing the at least one monitor sensor from the second location.

7. The method as claimed in claim 6, wherein the at least one noise for calibration is a broadband noise;
wherein the broadband noise is any one or any combination of a white, a pink, and a brown noise.

8. The method as claimed in claim 1, further comprising:
at least one reference sensor measuring at least one primary noise at a primary noise source;
wherein the at least one first and second noise are a superposition of the at least one primary noise and the at least one secondary noise at the first and second location, respectively.

9. The method as claimed in claim 8, further comprising:
generating a control signal by executing an adaptive filtering algorithm, comprising:
updating an adaptive filter based on the measured at least one primary noise and the estimated at least one second noise by executing the adaptive filtering algorithm;
generating the control signal by filtering the measured at least one primary noise by the updated adaptive filter; and
generating the at least one secondary noise, in response to the control signal, for reducing the at least one primary noise at the second location by the at least one sound transducer.

10. The method as claimed in claim 9, wherein the step of estimating at least one second noise comprises:
calculating a secondary signal \hat{Q}ₛ(n) representing the at least one secondary noise that would have been measured at the first location, based on the control signal and the secondary transfer function from the at least one sound transducer to the first location;
calculating a primary signal \hat{Q}₀(n) representing the at least one primary noise that would have been measured at the first location, based on the at least one first noise and the secondary signal \hat{Q}ₛ^{(v)}(n);
calculating a primary signal \hat{Q}ₛ^{(v)}(n) representing the at least one primary noise that would have been measured at the second location, based on the primary signal ê₀(n) at the first location and the primary transfer function;
calculating a secondary signal êₛ^{(v)}(n) representing the at least one secondary noise that would have been measured at the second location, based on the control signal and the secondary transfer functions from the at least one sound transducer to the second location; and
calculating a second error signal êₛ^{(v)}(n) based on the primary signal ê₀^{(v)}(n) and the secondary signal êₛ^{(v)}(n);
wherein the second error signal ê^{(v)}(n) represents the at least one second noise that would have been measured at the second location.

11. The method as claimed in claim 2, wherein
the step of the neural network optimizing the preliminary primary transfer function comprises:
using an Adaptive Moment Estimation, ADAM, optimizer, for optimizing the preliminary primary transfer function.

12. The method as claimed in claim 11, wherein the step of the neural network optimizing the preliminary primary transfer function comprises:
calculating a gradient of the error of prediction;
updating a momentum vector m and a velocity vector v;
calculating a predicted momentum vector m and a predicted velocity vector v;
updating the preliminary primary transfer function, based on the predicted momentum vector m and the predicted velocity vector v;
updating the plurality of predicted second noise based on the updated preliminary primary transfer function;
wherein the preliminary primary transfer function is a weight vector.

13. The method as claimed in claim 11, wherein the step of the neural network optimizing the preliminary primary transfer function comprises:
setting a predetermined value for each of following parameters for optimization:
a step size p, and
two forgetting factors β1 and β2; and
setting an initial value for each of following parameters for optimization:
the momentum vector m,
the velocity vector v,
a time step t, and
the weight vector w.

14. The method as claimed in claim 2, wherein the step of calculating the primary transfer function comprises:
optimizing a preliminary primary transfer function for each of the plurality of operating conditions by the neural network;
wherein the method further comprises:
prior to the step of estimating at least one second noise, determining a current operating condition of the vehicle, and
using the primary transfer function optimized for the current operating condition of the vehicle for estimating the at least one second noise.

15. A system for reducing noise within a cabin of a vehicle, the system comprising:
at least one error sensor configured to measure at least one first noise at a first location within the cabin, wherein the at least one error sensor is provided at the first location; and
a control circuit configured to select at least one sound zone from a plurality of sound zones within the cabin for reducing noise in said at least one sound zone, based on a presence of a driver and passenger(s) within the cabin, wherein the selected at least one sound zone corresponds to at least one zone occupied by the driver and/or passenger(s);
wherein the control circuit is configured to estimate at least one second noise that would have been measured at a second location within the selected at least one sound zone, based on a primary transfer function describing a primary acoustic path from the first location to the second location;
wherein the system further comprises:
at least one sound transducer configured to generate at least one secondary noise for reducing the at least one second noise that would have been measured at the second location.

16. The method as claimed in claim 9, wherein the adaptive filtering algorithm is a filtered-x least mean square, FxLMS, algorithm.
